(19) United States
(12) Patent Application Publication
(10) Pub. No.: US 2020/0272439 A1
(43) Pub. Date: Aug. 27, 2020

(54) DYNAMIC ADJUSTMENT OF GRAPHICAL USER INTERFACES IN RESPONSE TO LEARNED USER PREFERENCES

(71) Applicant: International Business Machines Corporation, Armonk, NY (US)

(72) Inventors: Mark Gregory Megerian, Rochester, MN (US); Thomas J. Eggebraaten, Rochester, MN (US); Marie Louise Setnes, Bloomington, MN (US); John Petri, St. Charles, MN (US)

(21) Appl. No.: 16/286,800

(22) Filed: Feb. 27, 2019

(51) Int. Cl. G06F 8/38; G06N 20/00; G06F 11/34

(52) U.S. Cl. CPC G06F 8/38; G06F 11/3438; G06N 20/00

(57) ABSTRACT

Embodiments provide for the dynamic adjustment of graphical user interfaces (GUIs) in response to learned user preferences via generating a plurality of scores for a plurality of action plans based on logical structures defined by a plurality of diagnosis paradigms that identify conditions addressable by individual action; determining a plurality of weights associated with the plurality of diagnosis paradigms, wherein a given weight of the plurality of weights is based on a historic frequency of selection of individual action plans from a GUI associated with a particular diagnosis paradigm; determining a concordance measure for each action plan relative to each other action plan based on a machine learning clustering of the action plans using the plurality of weights and the plurality of scores; and generating the GUI to present the plurality of diagnosis paradigms and the plurality of action plans based on a respective concordance measure for each action plan.

### BACKGROUND

The present invention relates to Graphical User Interfaces (GUI), and more specifically, to improving the functionality of how the GUI presents information to a user. Various designers of GUIs may select which elements of those GUIs to emphasize, or allow users to select which elements to emphasize (e.g., via dialog boxes).

### SUMMARY

According to one embodiment of the present invention, dynamic adjustment of graphical user interfaces in response to learned user preferences is provided via a method that includes: generating a plurality of scores for a plurality of candidate action plans based on logical structures defined by a plurality of diagnosis paradigms that identify conditions addressable by individual candidate action plans of the plurality of candidate action plans; determining a plurality of weights associated with the plurality of diagnosis paradigms, wherein a given weight of the plurality of weights is based on a historic frequency of selection of individual candidate action plans from a Graphical User Interface (GUI) associated with a particular diagnosis paradigm; determining a concordance measure for each candidate action plan relative to each other candidate action plan based on a machine learning clustering of the candidate action plans using the plurality of weights and the plurality of scores; and generating the GUI to present the plurality of diagnosis paradigms and the plurality of candidate action plans based on a respective concordance measure for each candidate action plan.

According to one embodiment of the present invention, dynamic adjustment of graphical user interfaces in response to learned user preferences is provided via a system that includes: a processor; and a memory storage device, including instructions that when performed by the processor cause the processor to: generate a plurality of scores for a plurality of candidate action plans based on logical structures defined by a plurality of diagnosis paradigms that identify conditions addressable by individual candidate action plans of the plurality of candidate action plans; determine a plurality of weights associated with the plurality of diagnosis paradigms, wherein a given weight of the plurality of weights is based on a historic frequency of selection of individual candidate action plans from a Graphical User Interface (GUI) associated with a particular diagnosis paradigm; determine a concordance measure for each candidate action plan relative to each other candidate action plan based on a machine learning clustering of the candidate action plans using the plurality of weights and the plurality of scores; and generate the GUI to present the plurality of diagnosis paradigms and the plurality of candidate action plans based on a respective concordance measure for each candidate action plan.

According to one embodiment of the present invention, dynamic adjustment of graphical user interfaces in response to learned user preferences is provided via a computer readable storage device including instructions that when performed by a processor cause the processor to perform an operation, the operation comprising: generating a plurality of scores for a plurality of candidate action plans based on logical structures defined by a plurality of diagnosis paradigms that identify conditions addressable by individual candidate action plans of the plurality of candidate action plans; determining a plurality of weights associated with the plurality of diagnosis paradigms, wherein a given weight of the plurality of weights is based on a historic frequency of selection of individual candidate action plans from a Graphical User Interface (GUI) associated with a particular diagnosis paradigm; determining a concordance measure for each candidate action plan relative to each other candidate action plan based on a machine learning clustering of the candidate action plans using the plurality of weights and the plurality of scores; and generating the GUI to present the plurality of diagnosis paradigms and the plurality of candidate action plans based on a respective concordance measure for each candidate action plan.

### BRIEF DESCRIPTION OF THE SEVERAL VIEWS OF THE DRAWINGS

FIG. 1 illustrates a computing system, according to aspects of the present disclosure.

FIGS. 2A-2H illustrate a first sequence of Graphical User Interfaces as a user interacts with the presented elements thereof, according to aspects of the present disclosure.

FIG. 3A-3H illustrate a second sequence of Graphical User Interfaces as a user interacts with the presented elements thereof, according to aspects of the present disclosure.

FIG. 4 is a flowchart of a method for dynamically adjusting a Graphical User Interface in response to learned user preferences, according to aspects of the present disclosure.

### DETAILED DESCRIPTION

Various Graphical User Interfaces (GUI) may be presented in various formats to present ranked options that users may select from. As discussed herein, a paradigm (also referred to as a diagnosis paradigm) is a logical structure that is used to identify a condition (or several conditions) that may be addressed by one or more action plans. The paradigms provide rankings for the various action plans and identify which action plans are to be displayed in a GUI and what order those action plans are to be presented in. For example, a maintenance technician may be presented with a GUI that shows several action plans for troubleshooting a nonconformance in a device or structure (e.g., an air conditioner, a building, a computer, a vehicle) and several paradigms (e.g., a manufacturer's recommendation, a company policy, previous technician's notes) that recommend one action plan over another action plan. In another example, a healthcare professional may be presented with a GUI that shows several action plans for treating a condition in a patient and several paradigms (e.g., Hospital policy, National Code, Previous treatment plans, research notes) that recommend one action plan over another action plan. Similarly, the various paradigms may be ranked so that a mandated or more-trusted paradigm is presented with greater prominence in the GUI.

A GUI may be configured to display the highest ranked action plans and/or the highest ranked paradigms more prominently than lower ranked action plans and/or paradigms (i.e., highlighting a preferred option), but users may select lower-ranked action plans or may select action plans based on lower ranked paradigms. Because the user's preferences do not alter what a predefined paradigm recommends, alternatives to the initial highlighting may improve the user experience and thereby improve the functionality of the computer device used to provide the GUI.

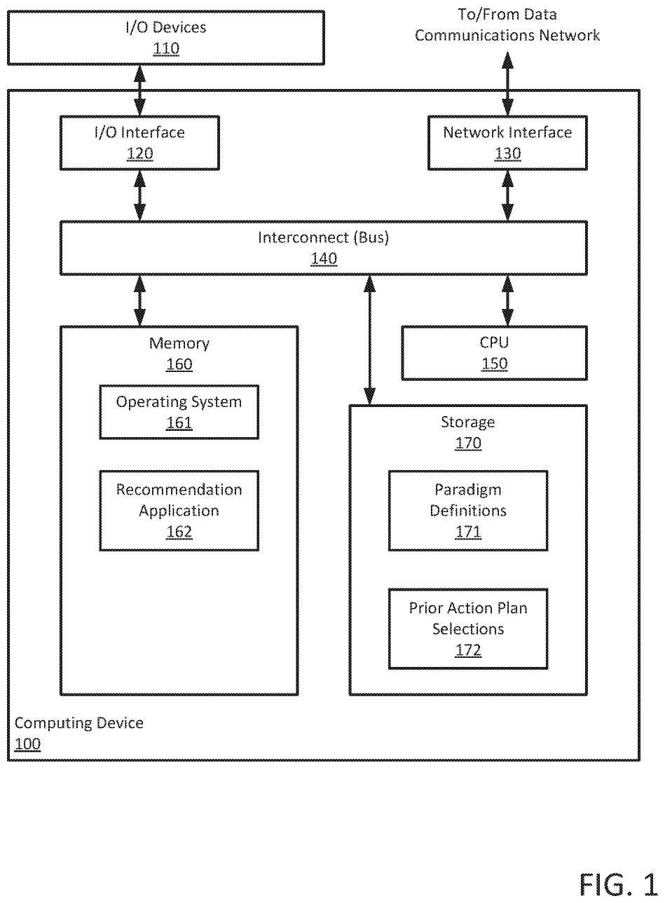

FIG. 1 illustrates a computing system 100, which may be a personal computer, a laptop, a tablet, a smartphone, etc. As shown, the computing system 100 includes, without limitation, a central processing unit (CPU) 150, a network interface 130, an interconnect 140, a memory 160, and storage 170. The computing system 100 may also include an I/O device interface 120 connecting I/O devices 110 (e.g., keyboard, display and mouse devices) to the computing system 100.

The CPU 150 retrieves and executes programming instructions stored in the memory 160. Similarly, the CPU 150 stores and retrieves application data residing in the memory 160. The interconnect 140 facilitates transmission, such as of programming instructions and application data, between the CPU 150, I/O device interface 120, storage 170, network interface 140, and memory 160. CPU 150 is included to be representative of a single CPU, multiple CPUs, a single CPU having multiple processing cores, and the like. And the memory 160 is generally included to be representative of a random access memory. The storage 170 may be a disk drive storage device. Although shown as a single unit, the storage 170 may be a combination of fixed and/or removable storage devices, such as magnetic disk drives, flash drives, removable memory cards or optical storage, network attached storage (NAS), or a storage area-network (SAN). The storage 170 may include both local storage devices and remote storage devices accessible via the network interface 130.

Further, computing system 100 is included to be representative of a physical computing system as well as virtual machine instances hosted on a set of underlying physical computing systems. Further still, although shown as a single computing system, one of ordinary skill in the art will recognized that the components of the computing system 100 shown in FIG. 1 may be distributed across multiple computing systems connected by a data communications network.

As shown, the memory 160 includes an operating system 161 (e.g., Microsoft's WINDOWS® Operating System) and a recommendation application 162. The recommendation application 162 accesses one or more paradigm definitions 171 to determine which action plans to recommend to a user under a particular paradigm. The paradigm definitions 171 include a logical structure used to evaluate which action plans are to be recommended under certain conditions according to a respective diagnosis paradigm, and the recommendation application 162 evaluates several diagnosis paradigms in parallel. Depending on the logical structures of the paradigms, various action plans may be ranked higher or lower in different diagnosis paradigms, and the recommendation application 162 may display the recommendations according to the paradigm-specific scores in a GUI.

As selections of action plans from the GUI are received over time from various users, a corpus 172 of prior action plan selections is collected. The recommendation application 162 identifies which action plans are historically selected, by whom, and how often the user(s) selected the action plans (i.e., a frequency of selection). The recommendation application 162 learns the user preferences for action plans from the corpus 172 and highlights the user-preferred action plans in the GUI in parallel with the paradigm-specific ranking of the action plans via a secondary highlighting mechanism. For example, in a case where the GUI conveys the paradigm-specific ranking of the action plans via the order of presentation in the GUI (e.g., more-preferred action plans higher in the GUI than less-preferred action plans), the recommendation application 162 may display user-preferred action plans in a different color, size, or shape. In another example, in a case where the GUI conveys the paradigm-specific ranking of the action plans via a size, shape, or color in the GUI (e.g., more-preferred action plans larger in the GUI than less-preferred action plans, a color-scale matched to preference score), the recommendation application 162 may display user-preferred action plans in a different location-based order in the GUI to convey the learned user preferences. Stated differently, the recommendation application conveys the ranking defined by the logical structures via a first visual channel and the learned rankings in a second visual channel in the same GUI, which preserves display screen real estate while conveying more information to a user.

Additionally, by presenting the action plans as recommended by several paradigms in parallel, the recommendation application 162 may highlight various action plans based on the concordance between the several action plans. In some embodiments, when providing a concordance score for the several action plans, the recommendation application 162 may highlight action plans that are atypical, abnormal, unique, anomalous, or are otherwise assigned a low score for concordance. For example, if 1 out of N paradigms recommend action plan X, with or without regard to that paradigm highly recommending the unique action plan X, the recommendation application 162 may present action plan X with greater prominence in the GUI to bring the uniqueness of action plan X to a user's attention. In some embodiments, when providing a concordance score for the several action plans, the recommendation application 162 may highlight various action plans that are typical, usual, super-normal, common, shared, or otherwise in concordance with one another across several different paradigms. For example, if N out of N paradigms recommend action plan X, despite action plan X not be the highest recommended action plan in one or more of the N paradigms, the recommendation application 162 may present action plan X with greater prominence in the GUI to bring the high level of agreement between the paradigms on action plan X to a user's attention.

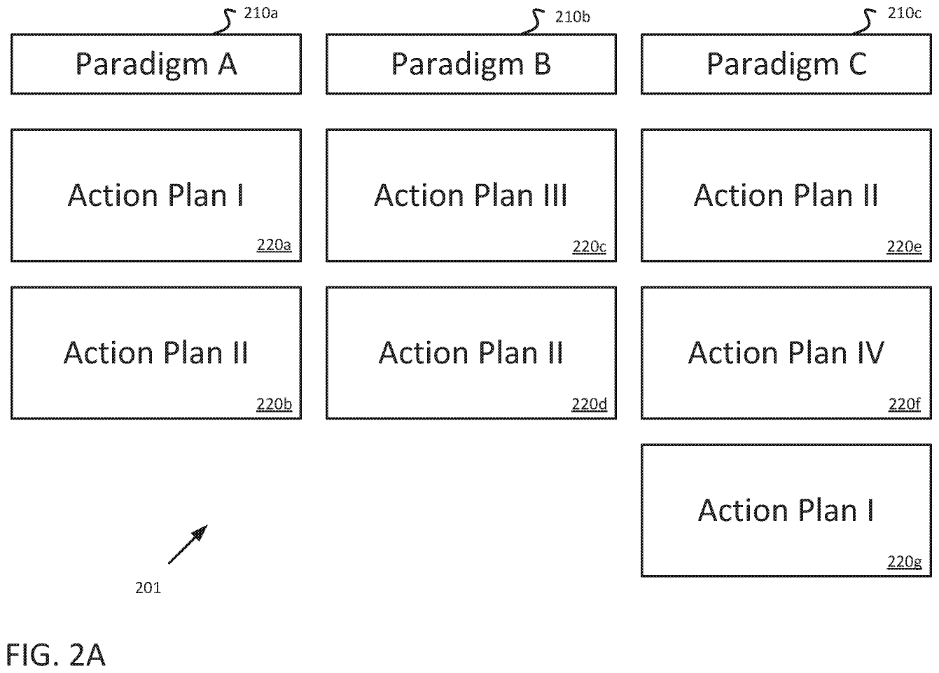

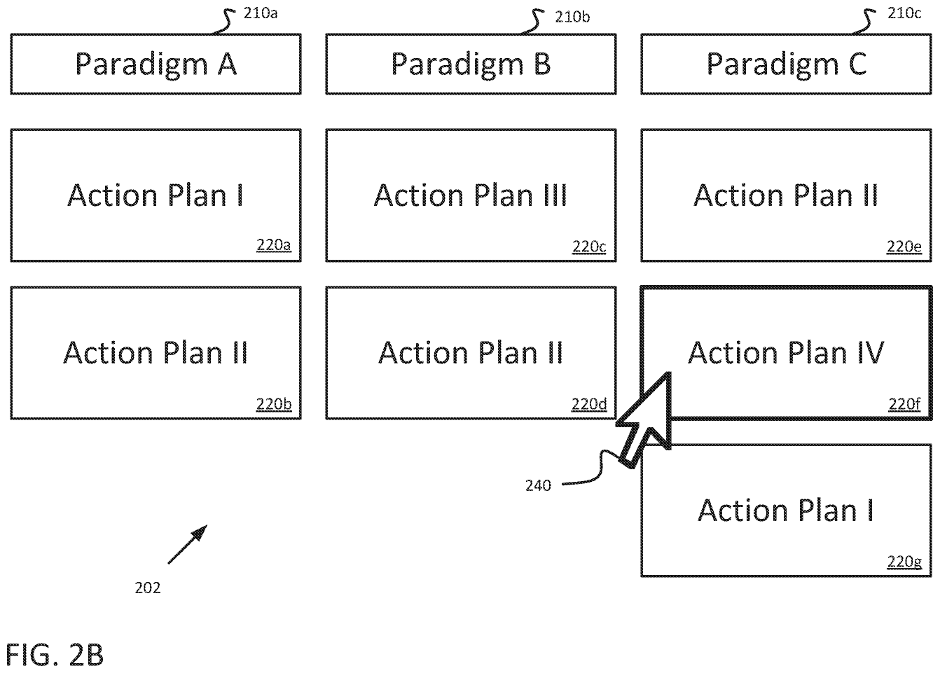

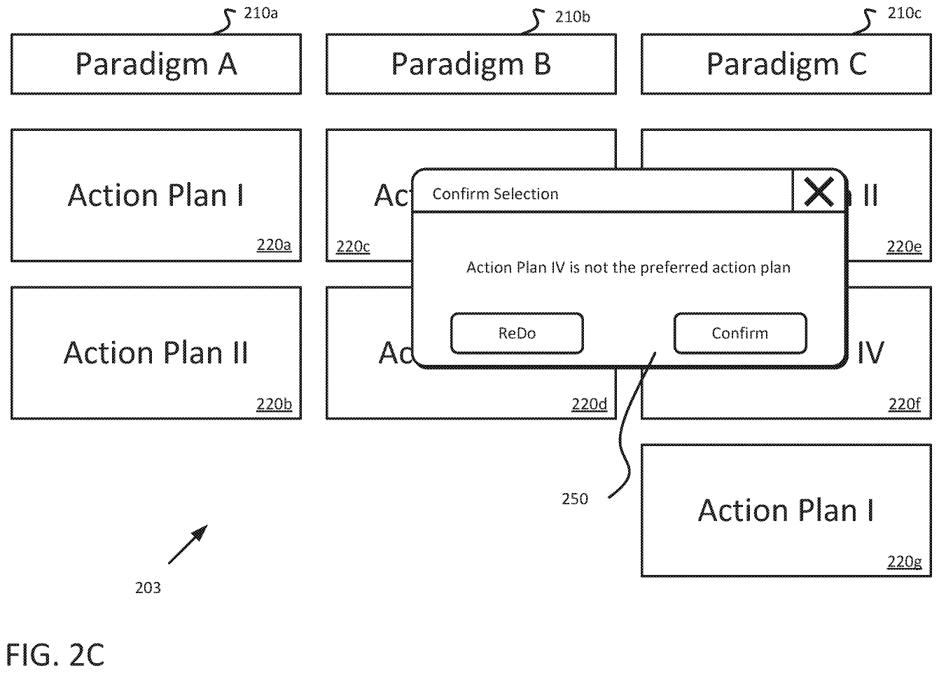

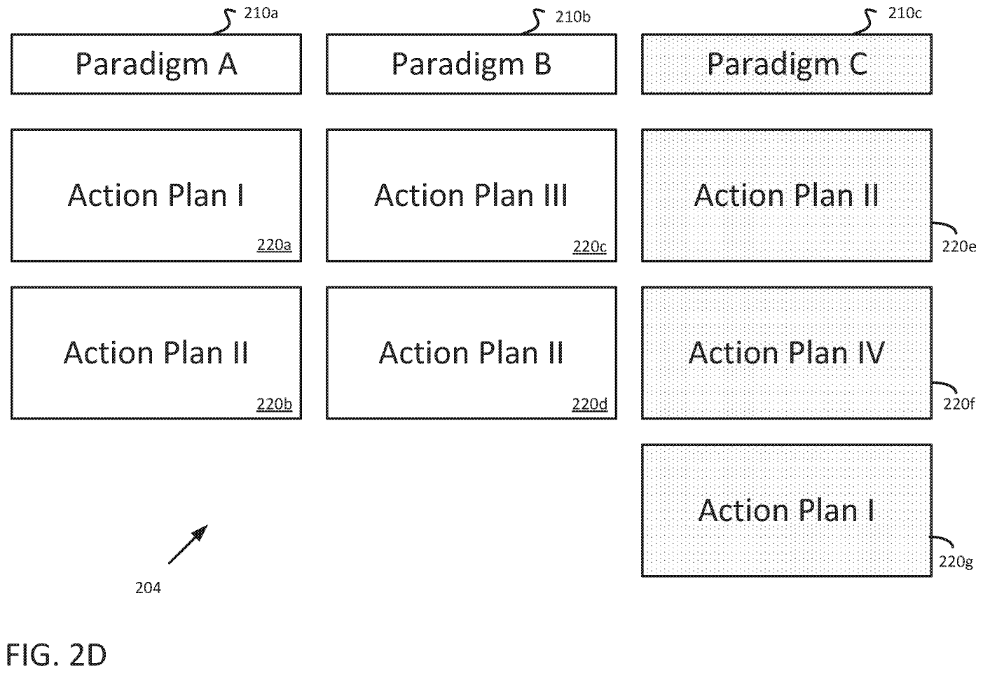

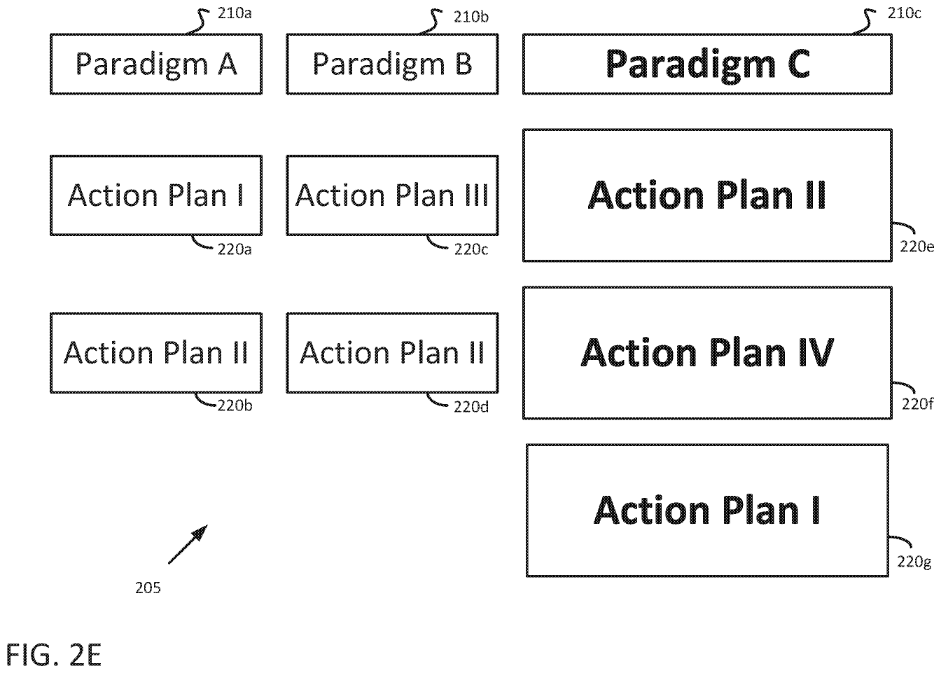

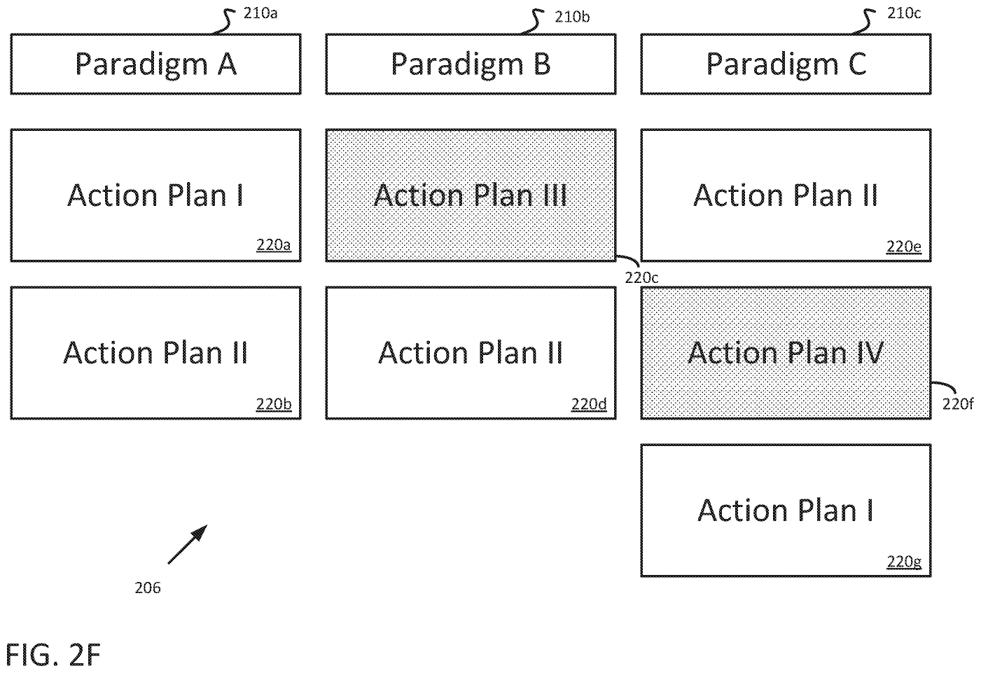

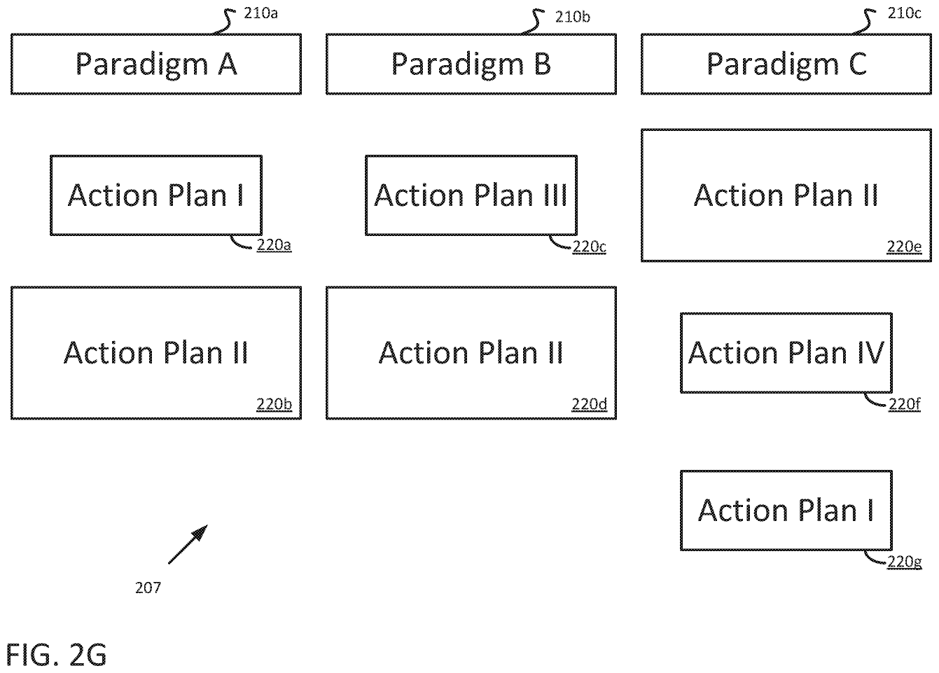

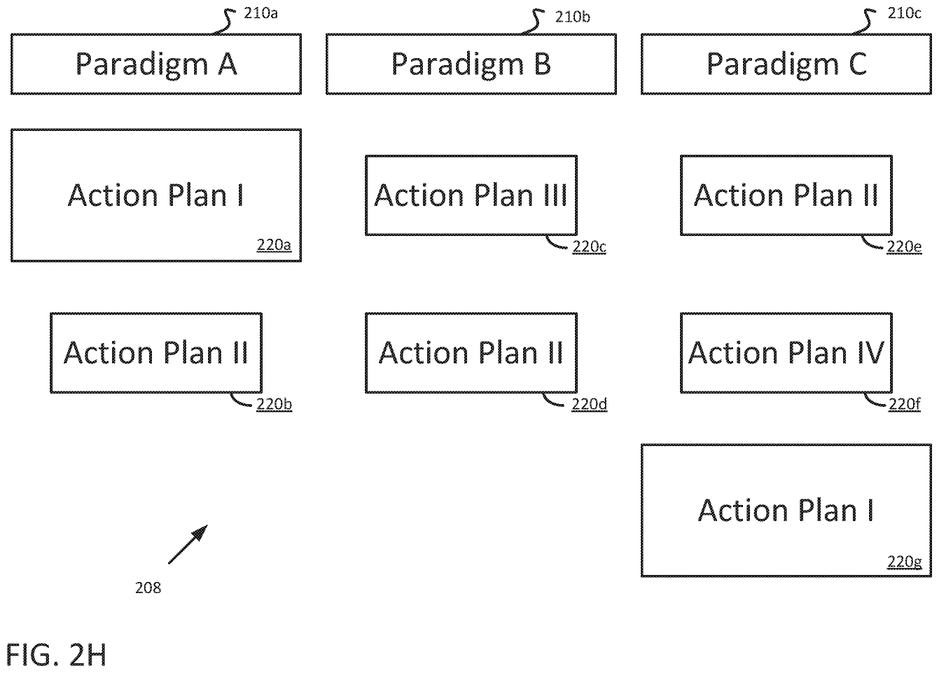

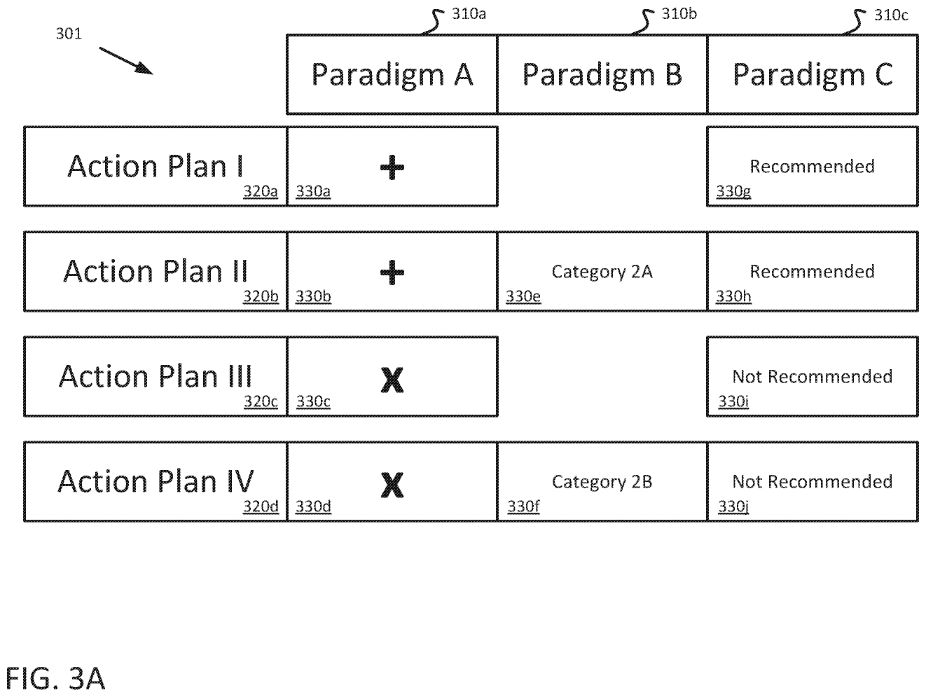

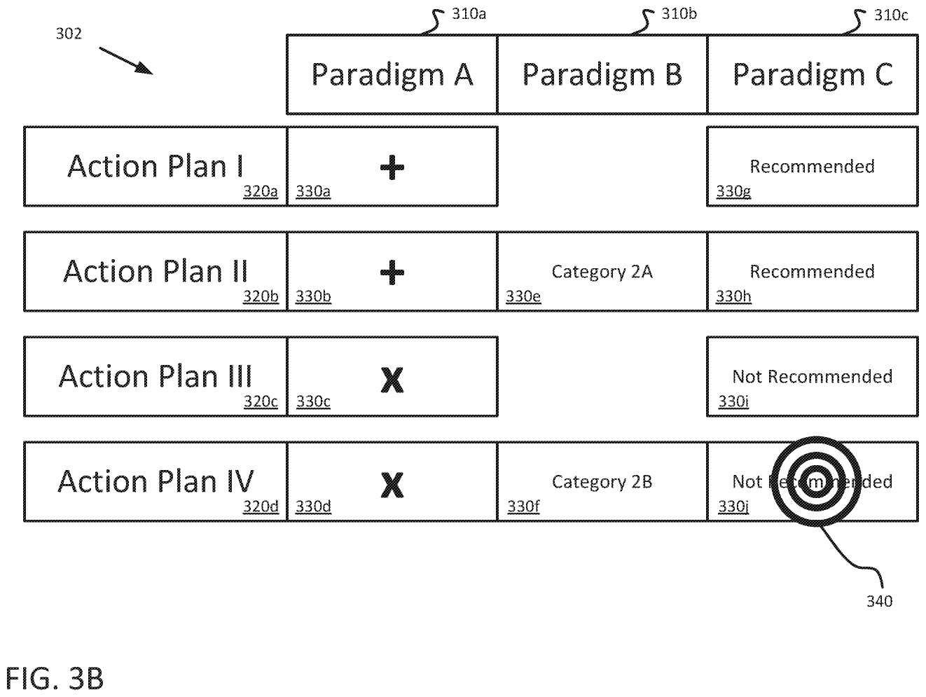

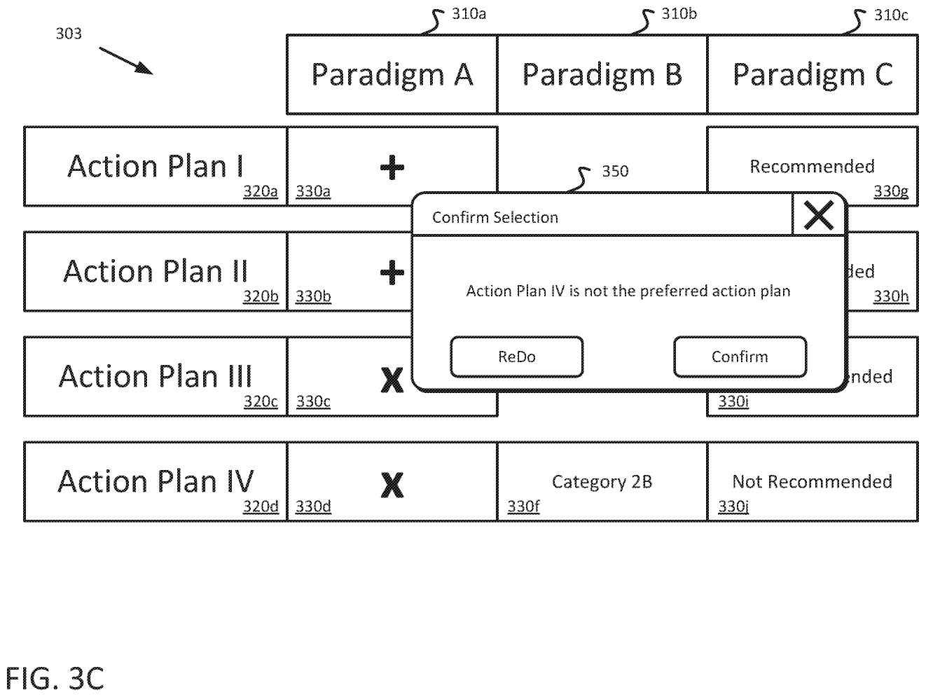

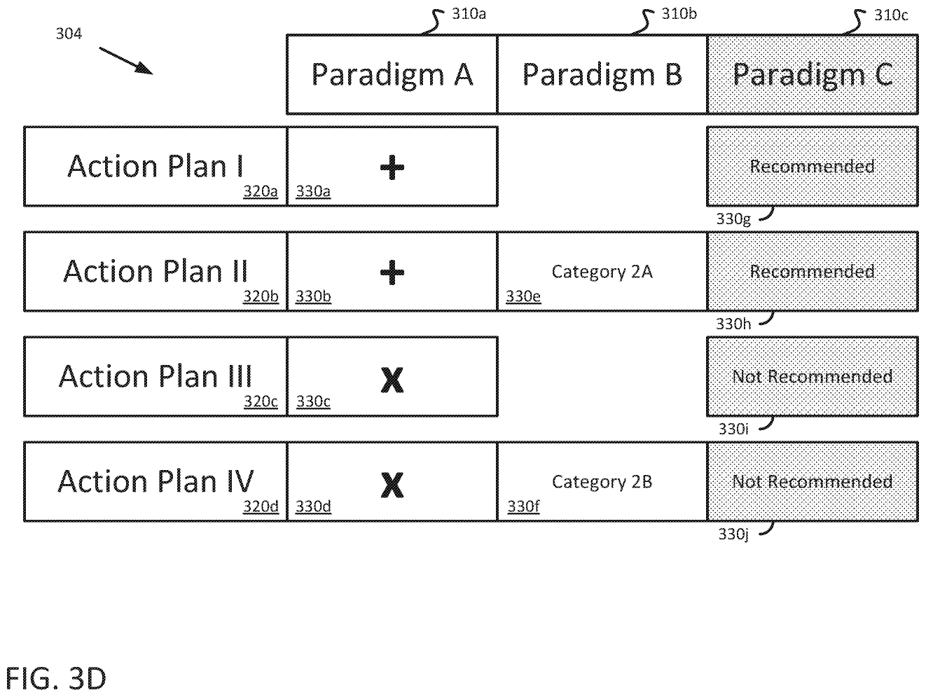

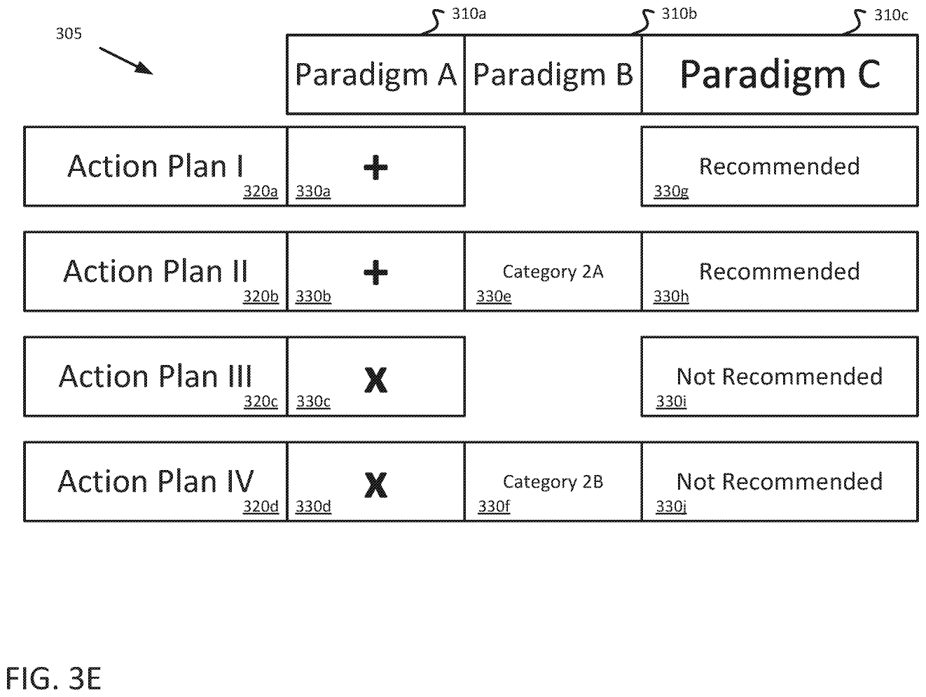

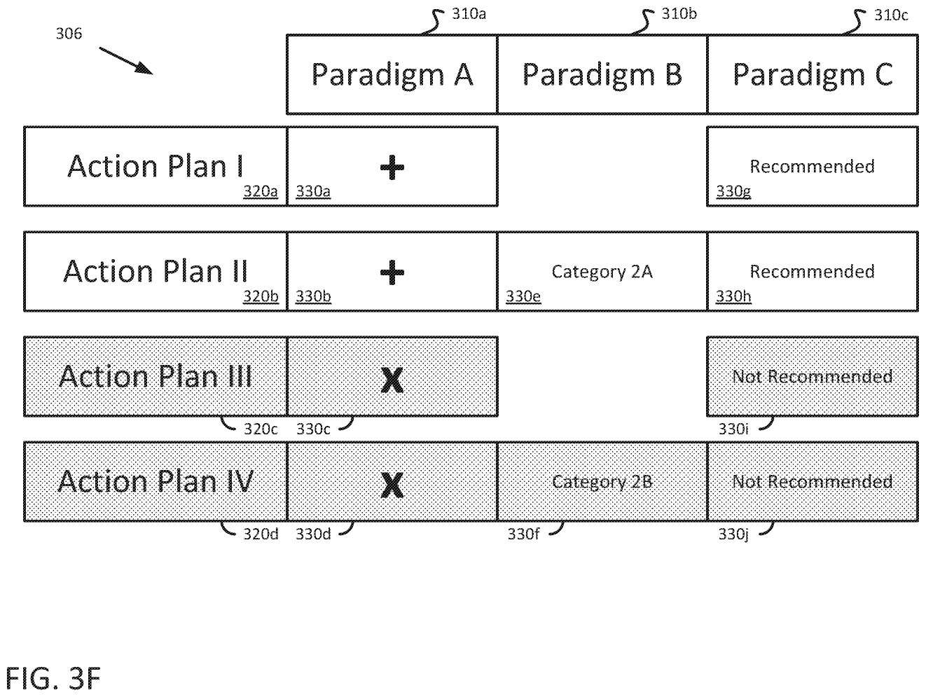

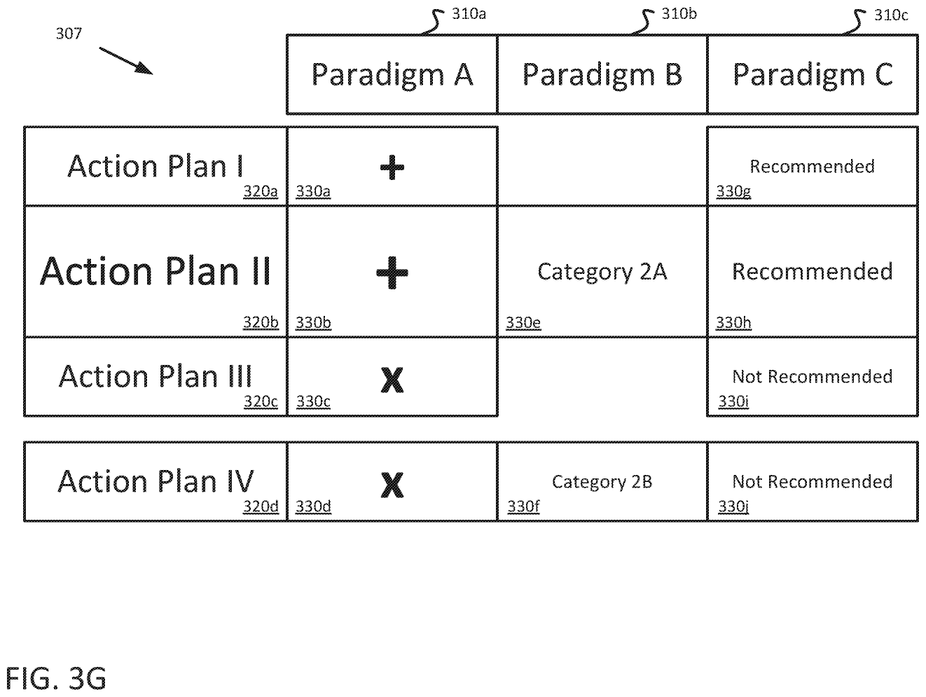

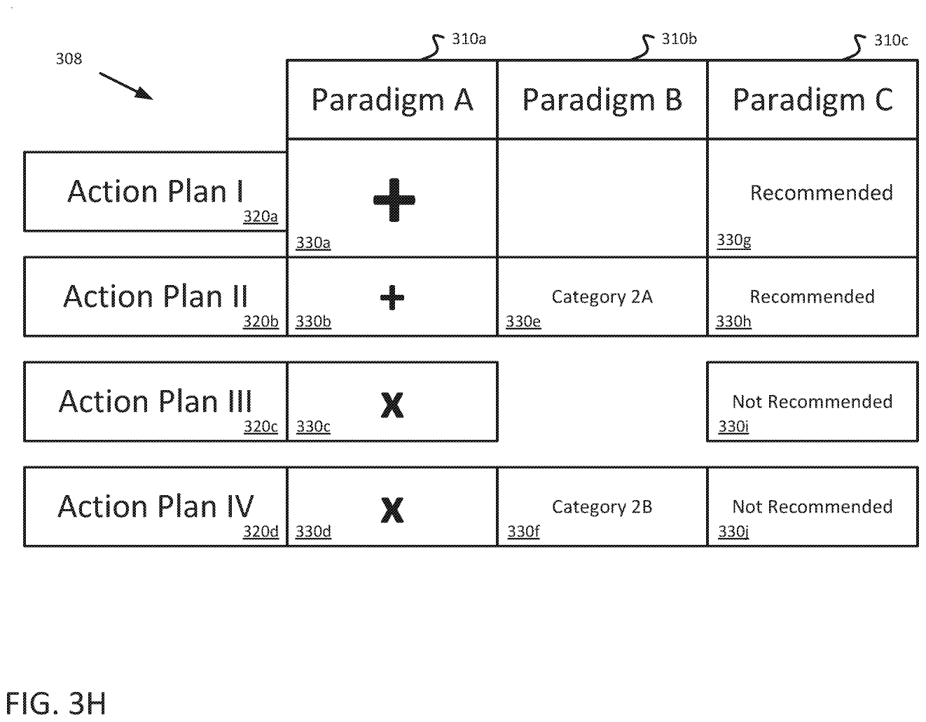

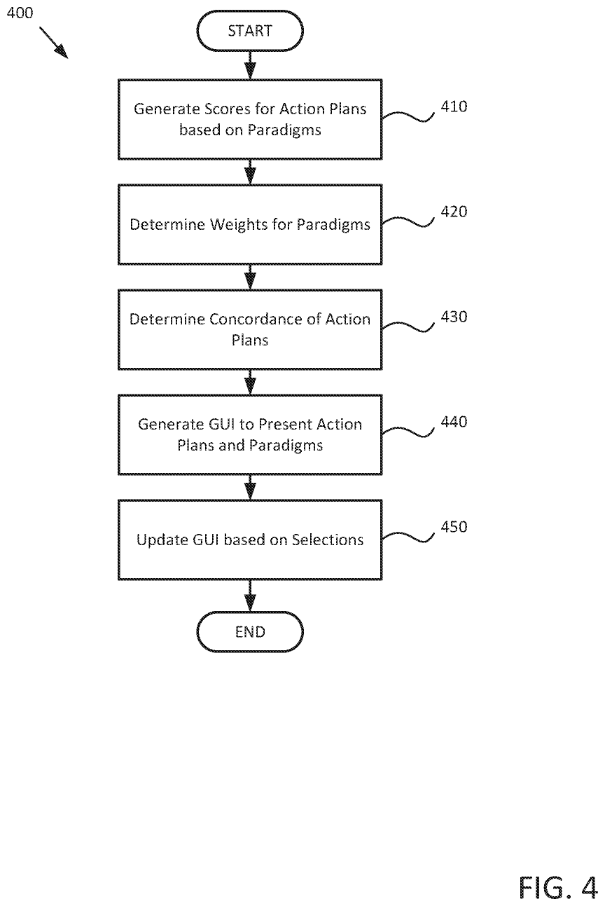

FIG. 2A-H illustrate a first sequence of GUIs as a user interacts with the presented elements thereof and FIG. 3A-3H illustrate a second sequence of GUIs as a user interacts with the presented elements thereof, according to aspects of the present disclosure. Each of the first sequence of GUIs and the second sequence of GUIs, illustrated in FIGS. 2A-2H and 3A-3H respectively, may be considered in conjunction with the flowchart of a method 400 for dynamically adjusting a GUI in response to learned user preferences.

FIGS. 2A and 3A illustrate an initial GUI layout 201/301 for the respective sequence of GUIs. FIGS. 2A-2H are laid out to present a row of paradigm indicators 210a-c under which columns of actions plan indicators 220a-g are arranged according to how a respective paradigm ranks the associated action plans. FIGS. 3A-3H are laid out to present a row of paradigm indicators 310a-c and a column of action plan indicators 320a-d that are used in conjunction to present plan ranking indicators 330a-j in alignment with the paradigm and action plan to display an associated rating of the action plan under the paradigm to the user.

In FIGS. 2A-2H, the individual action plan indicators 220a-g are organized under the paradigm indicators 210a-c according to the score assigned to the particular action plan by the associated paradigm (per block 410). For example, Paradigm A recommends Action Plan I higher than Action Plan II, and the first action plan indicator 220a is thus displayed more prominently than the second action plan indicator 220b. In contrast, Paradigm B recommends Action Plan III higher than Action Plan II (and does not recommend Action Plan I), and thus the third action plan indicator 220c is displayed more prominently than the fourth action plan indicator 220d.

In FIGS. 3A-3H, the individual action plan indicators 320a-d may be organized according to a preferred paradigm's ranking scheme, alphabetically, or under some other scheme. The individual ranking indicators 330a-j (generally, ranking indicators 330) are aligned with the associated paradigms and action plans in a grid, although action plans that are not recommended or referenced by a paradigm may not be associated with a ranking indicator 330. For example, under Paradigm B, Action Plan III is not recommended (e.g., the logical structure of Paradigm B ranks action plan III below a recommendation threshold) or referenced (e.g., Action Plan III is not a possible output of the logical structure) and thus no ranking indicator 330 is presented in FIGS. 3A-3H in association with Paradigm B and action Plan III. In another example, Action Plan III is not recommended or referenced under Paradigm A, and the third ranking indicator 330c, which is aligned with the first paradigm indicator 310a and the third action plan indicator 320c, provides a visual representation of how the action plan is ranked according to the associated paradigm. The ranking indicators 330 may convey how a particular action plan is evaluated by an associated paradigm according to a color scheme, text, iconographs or symbols, and combinations thereof, and each paradigm may use the same or different schemes to convey how highly a given action plan is rated.

The order in which the paradigm indicators 210a-c/310a-c are displayed relative to one another may be based on how a user has ranked the associated paradigms or the weights that the recommendation application 162 assigns to the paradigms. The recommendation application 162 determines the weights to assign to the paradigms (per block 420) based on how often users have selected action plans associated with the particular paradigms. In some embodiments, when an action plan is associated with multiple paradigms (such as Action Plan II being associated with Paradigms A, B, and C in the examples illustrated in FIGS. 2A-2H and 3A-3H), a selection of that action plan is treated as a selection for each of the multiple paradigms. In other embodiments, when an action plan is associated with multiple paradigms, a selection of that action plan is tracked to understand which paradigm the user based the selection on.

For example, in the initial layout 201/301, the recommendation application 162 generates the GUI with paradigms and associated action plans (per block 440) to present the paradigm indicators 210a-c/310a-c in an order that presents the initially preferred paradigm first (according to the reading order) to the user. The recommendation application 162 determines the weights assigned to the various paradigms (per block 420) to determine the order in which to present the paradigm indicators 210a-c/310a-c, and generates scores for the actions plans per the paradigm definitions 171 (per block 430) to determine which action plan indictors 220a-g/320a-d to display in association with the paradigms and an order for those action plan indicators 220a-g/320a-d to be displayed based on the scores. In various embodiments, the GUI may include the paradigm indicators for less-preferred paradigms off screen so that more-preferred paradigms are given more space on the display device (e.g., a user may scroll to or unhide less-preferred paradigms).

In the second layout 202/302, the recommendation application 162 recognizes a user selection of Action Plan IV as associated with Paradigm C. In the second layout 202 as illustrated in FIG. 2B, the recommendation application 162 recognizes a software selector 240, such as a cursor or keyboard command, as indicating a user selecting the action plan represented by the sixth action plan indicator 220f (i.e., Action Plan IV in the illustrated example). In the second layout 302 as illustrated in FIG. 3B, the recommendation application 162 recognizes a touch selector 340, such as a pressure or conductive selection via a touchscreen, as indicating a user selecting the action plan represented by the tenth ranking indicator 330j (i.e., Action Plan IV under Paradigm C in the illustrated example).

In the third layout 203/303, the recommendation application 162 updates the GUI to present a confirmation dialog 250/350. The recommendation application 162 may update the GUI (per block 450) to display a confirmation dialog 250/350 in response to receiving a selection of an action plan with particular characteristics that satisfy a confirmation threshold. For example, a selection of an action plan with a conformance score below a conformance threshold can trigger the recommendation application 162 to present a confirmation dialog 250/350 before finalizing the selection. In another example, selection of an action plan that is associated with a non-preferred paradigm can trigger the recommendation application 162 to present a confirmation dialog 250/350 before finalizing the selection. The confirmation dialog 250/350 illustrated in FIGS. 2C and 3C provides controls for a user to confirm or deny selection of a previously selected action plan, but other controls may be provided in other embodiments to request data from the user as to why a non-preferred action plan was selected, request authorization from another user, select the action plan for further review, etc.

The recommendation application 162 determines the concordance of the action plans (per block 430) that are to be presented in the GUI based on a machine learning algorithm clustering of the action plans. The scores assigned to each action plan by the logical structures of the paradigms are combined in a weighted average based on the weights determined from the paradigms (determined per block 420). The concordance measure indicates a level of similarity between various action plans so that action plans that are recommended across several paradigms are provided greater emphasis in the GUI, and action plans that are presented by fewer paradigms (or less-preferred paradigms) are given less emphasis. FIGS. 2D-2H and 3D-3H illustrate several examples in which the recommendation application 162 emphasizes action plans that are anomalous from other action plans in the GUI, or emphasizes action plans that are congruent with other action plans in the GUI.

In some embodiments, the concordance measure includes a determination of a difference from one paradigm to another paradigm for a given action plan. For example, a given action plan may be highly recommended for use (with a high score) under Paradigm A, but highly recommended to avoid (with a low score) under Paradigm B, and the difference between the two scores indicates that the given action plan is anomalous. For example, an action plan of “turn off the machine and turn the machine on again” may be highly recommended by a diagnosis paradigm from a manufacturer, but may be recommended against as unnecessary or counter-productive by a diagnosis paradigm from a site coordinator (e.g., for a mission critical machine that cannot be turned off).

In some embodiments, the concordance measure includes a determination of a difference of one paradigm's assessment of an action plan from the collective paradigm's assessment of the action plan. For example, a given action plan may be highly recommended for use under Paradigm A, but highly recommended to avoid (with a low score) under Paradigm B, C, D, etc. and the difference between the score assigned by Paradigm A and the aggregate score assigned by all of the Paradigms indicates that the assessment under Paradigm A (and therefore potentially Paradigm A) is anomalous. For example, an action plan of “turn off the machine and turn the machine on again” may be highly recommended to perform by several paradigms, but highly recommended to not perform by one paradigm, and the difference in the assigned score for that action plan from the aggregate score may cause the recommendation application 162 to treat that action plan or the one paradigm as anomalous.

In the fourth layout 204/304, the recommendation application 162 has generated the GUI (per block 440) to highlight the action plans of a preferred paradigm using a different color than the action plans of other paradigms. The recommendation application 162 may use various colors (or animated sequences of colors) to redirect a user's attention to or away from various paradigms and the action plans associated with those paradigms. In FIG. 2D, the recommendation application 162 presents the third paradigm indicator 210c and the associated fifth, sixth, and seventh action plan indicators 220e-g in a different color than the first and second paradigm indicators 210a-b and the associated first through fourth action plan indicators 220a-d to draw a user's attention to the action plans associated with Paradigm C. In FIG. 3D, the recommendation application 162 presents the third paradigm indicator 310c and the associated seventh through tenth ranking indicators 340g-j in a different color than the first and second paradigm indicators 310a-b and the associated first through sixth ranking indicators 340a-f to draw a user's attention to the action plans associated with Paradigm C and how Paradigm C evaluates those action plans.

In the fifth layout 205/305, the recommendation application 162 has generated the GUI (per block 440) to highlight the action plans of a preferred paradigm using a different size than the action plans of other paradigms. The recommendation application 162 may use various size (or animated sequences of sizes) to redirect a user's attention to or away from various paradigms and the action plans associated with those paradigms. In FIG. 2E, the recommendation application 162 presents the third paradigm indicator 210c and the associated fifth, sixth, and seventh action plan indicators 220e-g in a larger size than the first and second paradigm indicators 210a-b and the associated first through fourth action plan indicators 220a-d to draw a user's attention to the action plans associated with Paradigm C. In FIG. 3E, the recommendation application 162 presents the third paradigm indicator 310c and the associated seventh through tenth ranking indicators 340g-j in a larger size than the first and second paradigm indicators 310a-b and the associated first through sixth ranking indicators 340a-f to draw a user's attention to the action plans associated with Paradigm C and how Paradigm C evaluates those action plans.

In the sixth layout 206/306, the recommendation application 162 has generated the GUI (per block 440) to highlight anomalous action plans using a different color than the non-anomalous action plans. For example, because Action Plan III and Action Plan IV are recommended by one Paradigm, the recommendation application 162 may determine that Action Plan III and Action Plan IV are anomalous based on the respective conformance measures (determined per block 430), and display the action plan indicators 220/320 and/or ranking indicators 330 for these Action Plans differently than other indicators in the GUI. In FIG. 2F, the recommendation application 162 presents the third and sixth action plan indicators 220c and 220f in a different color than the other action plan indicators based on Action Plan III and Action Plan IV being determined to be anomalous relative to Action Plan I and Action Plan II. In FIG. 3F, the recommendation application 162 presents the third and fourth action plan indicators 320c-d and the associated ranking indicators 330c-d, 330f, and 330i-j in a different color than the other action plan indicators 320 and ranking indicators 330 based on Action Plan III and Action Plan IV being determined to be anomalous relative to Action Plan I and Action Plan II.

In the seventh layout 207/307, the recommendation application 162 has generated the GUI (per block 440) to highlight concordant action plans using a different size than the non-concordant action plans. For example, because Action Plan II is recommended by all of the Paradigms, the recommendation application 162 may determine that Action Plan II is concordant (per block 430), and display the action plan indicators 220/320 and/or ranking indicators 330 for Action Plan II differently than other indicators in the GUI. In FIG. 2G, second, fourth, and fifth action plan indicators 220b, 220d, and 220e that are associated with Action Plan II are displayed larger than the other action plan indicators 220 that are associated with different Action Plans. In FIG. 3G, the second action plan indicator 320b and the second, fifth, and eighth ranking indicators 330b, 330e, and 330h that are associated with Action Plan II are displayed larger than the other action plan indicators 320 and ranking indicators 330 that are associated with different Action Plans.

In the eight layout 208/308, the recommendation application 162 has generated the GUI (per block 440) to highlight a preferred action plan from a preferred paradigm across several paradigms by using a different size than the other action plans. For example, if Paradigm A is the highest weighted Paradigm (i.e., a preferred paradigm) and Action Plan I is the highest scoring Action Plan (i.e., a preferred action plan) thereof, the recommendation application 162 may highlight Action Plan I across the GUI. In FIG. 2H, the recommendation application 162 presents the first action plan indicator 220a and the seventh action plan indicator 220g that are associated with the Action Plan I as larger than the other action plan indicators 220 associated with other Action Plans. In FIG. 3H, the recommendation application 162 presents the first ranking indicator 330a and the seventh ranking indicator 330g that are associated with the Action Plan I as larger than the other ranking indicators 330 associated with other Action Plans.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

The claims are as follows:

1. A method comprising:
generating a plurality of scores for a plurality of candidate action plans based on logical structures defined by a plurality of diagnosis paradigms that identify conditions addressable by individual candidate action plans of the plurality of candidate action plans;
determining a plurality of weights associated with the plurality of diagnosis paradigms, wherein a given weight of the plurality of weights is based on a historic frequency of selection of the individual candidate action plans from a Graphical User Interface (GUI) associated with a particular diagnosis paradigm, wherein a given candidate action plan is displayed via a plurality of instances in the GUI in association with at least two diagnosis paradigms so that, in response to receiving a selection of the given candidate action plan and determining that a selected instance of the plurality of instances is associated with a given diagnosis paradigm of the at least two diagnosis paradigms, selection of the given candidate action plan is treated as being associated only with the given diagnosis paradigm;
determining a concordance measure for each one of the plurality of candidate action plans relative to each other one of the plurality of candidate action plans based on a machine learning clustering of the plurality of candidate action plans using the plurality of weights and the plurality of scores; and
generating the GUI to present the plurality of diagnosis paradigms and the plurality of candidate action plans based on a respective concordance measure for each one of the candidate action plans.

2. The method of claim 1, further comprising:
in response to determining that a given concordance measure for the given candidate action plan selected in the GUI is below a predefined threshold, displaying a request to confirm the selection in the GUI.

3. The method of claim 1, wherein each one of the plurality of candidate action plans is displayed in the GUI via visual indicators, wherein the visual indicators for those candidate action plans associated with a concordance score that satisfies a concordance threshold differ in color or size from the visual indicators for other candidate action plans displayed in the GUI that do not satisfy the concordance threshold.

4. The method of claim 1, further comprising:
determining a difference between a first score and a second score of the plurality of scores for the given candidate action plan, wherein the first score and the second score are generated based on a first diagnosis paradigm and a second diagnosis paradigm respectively;
in response to the difference between the first score and the second score exceeding an anomaly threshold, determining that the given candidate action plan is anomalous; and
modifying the GUI to emphasize the given candidate action plan as anomalous.

5. The method of claim 1, further comprising:
determining an aggregate score for the given candidate action plan based on the plurality of scores;
determining a difference between a first score generated based on a particular paradigm and the aggregate score; and
in response to determining that the difference exceeds an anomaly threshold, modifying the GUI to emphasize the given candidate action plan as anomalous.

6. (canceled)

7. The method of claim 1, wherein the historic frequency of selection is based on selections received from one of:
a current individual user;
a selected individual user; and
a predefined cohort of users.

8. A system comprising:
a processor; and
a memory storage device, including instructions that when performed by the processor cause the processor to:
generate a plurality of scores for a plurality of candidate action plans based on logical structures defined by a plurality of diagnosis paradigms that identify conditions addressable by individual candidate action plans of the plurality of candidate action plans;
determine a plurality of weights associated with the plurality of diagnosis paradigms, wherein a given weight of the plurality of weights is based on a historic frequency of selection of individual candidate action plans from a Graphical User Interface (GUI) associated with a particular diagnosis paradigm, wherein a given candidate action plan is displayed via a plurality of instances in the GUI in association with at least two diagnosis paradigms so that, in response to receiving a selection of the given candidate action plan and determining that a selected instance of the plurality of instances is associated with a given diagnosis paradigm of the at least two diagnosis paradigms, selection of the given candidate action plan is treated as being associated only with the given diagnosis paradigm;
determine a concordance measure for each one of the plurality of candidate action plans relative to each other one of the plurality of candidate action plans based on a machine learning clustering of the plurality of candidate action plans using the plurality of weights and the plurality of scores; and
generate the GUI to present the plurality of diagnosis paradigms and the plurality of candidate action plans based on a respective concordance measure for each one of the candidate action plans.

9. The system of claim 8, wherein the instructions when performed by the processor further cause the processor to:
in response to determining that a given concordance measure for the given candidate action plan selected in the GUI is below a predefined threshold, display a request to confirm the selection in the GUI.

10. The system of claim 8, wherein each one of the plurality of candidate action plans is displayed in the GUI via visual indicators, wherein the visual indicators for those candidate action plans associated with a concordance score that satisfies a concordance threshold differ in color or size from the visual indicators for other candidate action plans displayed in the GUI that do not satisfy the concordance threshold.

11. The system of claim 8, wherein the instructions further cause the processor to:
determine a difference between a first score and a second score of the plurality of scores for the given candidate action plan, wherein the first score and the second score are generated based on a first diagnosis paradigm and a second diagnosis paradigm respectively;
in response to the difference between the first score and the second score exceeding an anomaly threshold, determine that the given candidate action plan is anomalous; and
modify the GUI to emphasize the given candidate action plan as anomalous.

12. The system of claim 8, the instructions further cause the processor to:
determine an aggregate score for the given candidate action plan based on the plurality of scores;
determine a difference between a first score generated based on a particular paradigm and the aggregate score; and
in response to determining that the difference exceeds an anomaly threshold, modify the GUI to emphasize the given candidate action plan as anomalous.

13. (canceled)

14. The system of claim 8, wherein the historic frequency of selection is based on selections received from one of:
a current individual user;
a selected individual user; and
a predefined cohort of users.

15. A computer readable storage device including instructions that when performed by a processor cause the processor to perform an operation, the operation comprising:
generating a plurality of scores for a plurality of candidate action plans based on logical structures defined by a plurality of diagnosis paradigms that identify conditions addressable by individual candidate action plans of the plurality of candidate action plans;
determining a plurality of weights associated with the plurality of diagnosis paradigms, wherein a given weight of the plurality of weights is based on a historic frequency of selection of individual candidate action plans from a Graphical User Interface (GUI) associated with a particular diagnosis paradigm, wherein a given candidate action plan is displayed via a plurality of instances in the GUI in association with at least two diagnosis paradigms so that, in response to receiving a selection of the given candidate action plan and determining that a selected instance of the plurality of instances is associated with a given diagnosis paradigm of the at least two diagnosis paradigms, selection of the given candidate action plan is treated as being associated only with the given diagnosis paradigm;
determining a concordance measure for each one of the plurality of candidate action plans relative to each other one of the plurality of candidate action plans based on a machine learning clustering of the plurality of candidate action plans using the plurality of weights and the plurality of scores; and
generating the GUI to present the plurality of diagnosis paradigms and the plurality of candidate action plans based on a respective concordance measure for each one of the candidate action plans.

16. The computer readable storage device of claim 15, the operation further comprising:
in response to determining that a given concordance measure for the given candidate action plan selected in the GUI is below a predefined threshold, displaying a request to confirm the selection in the GUI.

17. The computer readable storage device of claim 15, wherein each one of the plurality of candidate action plans is displayed in the GUI via visual indicators, wherein the visual indicators for those candidate action plans associated with a concordance score that satisfies a concordance threshold differ in color or size from the visual indicators for other candidate action plans displayed in the GUI that do not satisfy the concordance threshold.

18. The computer readable storage device of claim 15, wherein the operation further comprises:
determining a difference between a first score and a second score of the plurality of scores for the given candidate action plan, wherein the first score and the second score are generated based on a first diagnosis paradigm and a second diagnosis paradigm respectively;
in response to the difference between the first score and the second score exceeding an anomaly threshold, determining that the given candidate action plan is anomalous; and
modifying the GUI to emphasize the given candidate action plan as anomalous.

19. The computer readable storage device of claim 15, wherein the operation further comprises:
determining an aggregate score for the given candidate action plan based on the plurality of scores;
determining a difference between a first score generated based on a particular paradigm and the aggregate score; and
in response to determining that the difference exceeds an anomaly threshold, modifying the GUI to emphasize the given candidate action plan as anomalous.

20. (canceled)
